(19) United States
(12) Patent Application Publication
(10) Pub. No.: US 2026/0153701 A1
(43) Pub. Date: Jun. 4, 2026

(54) PRECISION INSERTION DEVICE FOR INSERTION LINE OF LENS MODULE

(71) Applicant: ADS TECH CO.,LTD., Hwaseong-si (KR)

(72) Inventor: Kwang Yeoul SONG, Hwaseong-si (KR)

(21) Appl. No.: 18/697,471

(22) PCT Filed: Jun. 20, 2023
(86) PCT No.: PCT/KR2023/008513

§ 371 Date: Mar. 31, 2024

(51) Int. Cl. G02B 7/00

(52) U.S. Cl. CPC G02B 7/005

(57) ABSTRACT

In an installation process of a lens module of a device manufactured through a process in which the lens module such as an optical sensor is installed in a lens housing, in order to provide a technology capable of increasing a manufacturing yield of the device by allowing a manual work of an operator or a complicated epoxy fixing process to be completely unnecessary, according to one embodiment of the present invention, a precision insertion device for an insertion line of a lens module includes: a lens housing fixing unit for fixing a lens housing, which has an insertion space into which a lens module having a cylindrical shape, having an end side coupled with a lens, and formed therein with an empty space is inserted, and a through-line formed through the lens housing to allow one region of an outer surface of the lens housing to be connected to the insertion space; a gripper inserted into the lens module through an opening formed on an end side, which is opposite to the end side on which the lens of the lens module having the cylindrical shape is installed, so as to apply an external force toward an outer surface of a cylinder of the lens module to support the lens module, and moved in a first direction, which is a longitudinal direction of the insertion space, to insert the lens module into the insertion space; a focal point detection module having a capturing angle in a direction toward the lens along the empty space of the lens module so as to detect a focal point of the lens; and a control unit for controlling the movement of the gripper in the first direction according to a capturing result of the focal point detection module.

### TECHNICAL FIELD

The present invention relates to a technology for an insertion assembly device for a lens barrel in which a lens is inserted and a CCD and a lens housing, which is used for assembling lines of camera modules such as a LiDAR sensor and a camera/mobile phone camera, and more particularly, to a technology capable of inserting a lens module having a cylindrical shape into an insertion line space while automatically and precisely adjusting an insertion depth, and fixing the lens module to a sensor module very accurately and easily after the insertion, in order to precisely set a focal length of a lens.

### BACKGROUND ART

A LiDAR sensor refers to a technology capable of detecting a distance to an object, a direction, a velocity, a temperature, a material distribution, a concentration characteristic, and the like by emitting a laser to a target and identifying characteristics of a beam that is reflected and returned from the target. Such a LiDAR sensor may include a lens housing, a light source inserted into the lens housing to emit a specific laser at a predetermined focal length, and a lens module for concentrating a light from the light source at the focal length.

As described above, regarding an optical sensor including the LiDAR sensor, a reception sensitivity and a dynamic range of a receiver and characteristics of an optical filter and a lens may be main factors for determining performance of a LiDAR, basically with a laser power, a wavelength, a spectrum characteristic, a pulse width, and a pulse shape, and the like. In addition, a field-of-view (FOV), which represents a measurement angle of the receiver, a field stop for selecting a measurement range, an FOV overlap characteristic of the laser beam and the receiver, and the like may also be important features. A minimum time for collecting unit data with respect to a velocity of a light may be a factor for determining a range resolution, so that data collection and processing within a few ns may be required for a range resolution of 1 m or less.

In order to precisely manufacture such an optical sensor, an operation of inserting the lens module into the lens housing at a position that exactly corresponds to the focal length and fixing the lens module to the lens housing may be required.

A conventional technology for inserting a lens module to manufacture a sensor is shown in FIGS. 1 to 3. First, referring to FIG. 1, a lens module 10 may be inserted into an insertion space 21 for the lens module 10, which is provided in a lens housing 20, in a longitudinal direction. Thereafter, when a groove part 11 formed on an outer surface of the lens module 10 is located in a slit 22 formed in the lens housing 20, an operator may locate a pin 100 in the groove part 11, the operator may apply a force to the pin 100 in an insertion direction d1 and d2 to slightly move the lens module 10 in the direction d1 and d2, and since a position in which an image formed on the lens 12 appears clearly is a distance corresponding to a focal length according to a distance between the lens 12 installed in the lens module 10 and a substrate, the lens module 10 may be slightly moved by using the pin 100 as described above while the operator views at the position by directly capturing the image reflected on the lens 12 by using a camera. Thereafter, epoxy may be applied, the pin 100 may be removed, and the epoxy may be applied to a remaining portion.

Meanwhile, referring to FIG. 2, when a protrusion part 13 formed on the outer surface of the lens module 10 is brought guided to an outside through a slit 22-1 formed in the lens housing 20, the operator may move the protrusion part 13 in the direction d1 and d2 to slightly move a distance of the lens module 10 as described above.

Meanwhile, referring to FIG. 3, a thread line may be formed in the insertion space of the lens housing, in which a thread line 14 may be formed on the outer surface of the lens module 10 as shown in FIG. 3(a), a groove 15 may be formed on an end side of the lens 12 or an end side that is opposite to the lens 12, and the pin as shown in FIG. 1 or another insertion device may be fitted to the groove 15 and rotated in a direction R1 or the like so that the lens module 10 may be slightly moved in the direction d1 and d2 as shown in FIGS. 1 and 2 according to the rotation in the direction R1 by matching of thread lines 14 described above.

The conventional technologies described above have a serious problem in a process of precisely locating the lens module 10 in the lens housing 20 at the focal length of the lens 12 and fixing the lens housing 20 to the lens module 10. First, since a user performs a manual work by using the image formed on the lens 12, a backlash phenomenon that causes a slight movement when an external force is released in an operation using the pin 100 or the like may occur, so that an insertion depth may not be slightly controlled.

In addition, when the lens housing 20 and the lens module 10 are fixed to each other by applying the epoxy or the like after locating the lens module 10 at the position, for example, the epoxy may be primarily applied before removing the pin 100, and the epoxy may be secondarily applied to the insertion space of the pin 100 or the like after removing the pin 100, so that there is a possibility that the lens module may be slightly moved between the primary and secondary epoxy applications, and post-processing may be difficult upon the following fixing, and thus it may be very difficult to precisely control the insertion of the lens module, which causes quality of the optical sensor to deteriorate.

### DISCLOSURE

### Technical Problem

The present invention has been derived to solve the conventional problems related to precise installation between a lens module and a lens housing, which is subjected to insertion and installation of the lens module, as described above, and particularly, an object of the present invention is to provide a technology capable of performing precise automatic control for insertion of a lens module into an insertion space and an insertion depth, and enabling precise manufacture of a device in which a lens module such as an optical sensor is installed by eliminating a possibility of an error in fixing the lens module to the lens housing through a single process.

### Technical Solution

In order to achieve the above object, according to one embodiment of the present invention, a precision insertion device for an insertion line of a lens module includes: a lens housing fixing unit for fixing a lens housing, which has an insertion space into which a lens module having a cylindrical shape, having an end side coupled with a lens, and formed therein with an empty space is inserted, and a through-line formed through the lens housing to allow one region of an outer surface of the lens housing to be connected to the insertion space; a gripper inserted into the lens module through an opening formed on an end side, which is opposite to the end side on which the lens of the lens module having the cylindrical shape is installed, so as to apply an external force toward an outer surface of a cylinder of the lens module to support the lens module, and moved in a first direction, which is a longitudinal direction of the insertion space, to insert the lens module into the insertion space; a focal point detection module having a capturing angle in a direction toward the lens along the empty space of the lens module so as to detect a focal point of the lens; and a control unit for controlling the movement of the gripper in the first direction according to a capturing result of the focal point detection module.

The gripper may include: a pair of arms moved in a radial direction of the cylinder of the lens module while being moved in the longitudinal direction of the lens module, and having a portion inserted into the lens module through the opening; a first driving module for providing a movement force for moving the pair of arms in a second direction, which is the radial direction of the lens module; and a second driving module for providing a movement force for moving the pair of arms in the first direction.

A shape of an inner surface of the arm may be formed such that a line that connects inner surfaces of the pair of arms forms a circle.

The focal point detection module may include: a camera for capturing an image toward a gap between the pair of arms in the direction toward the lens along the empty space of the lens module; and a communication module for transmitting the image captured by the camera to the control unit in a real time.

The control unit may use an image formed on the lens among images received through the communication module to control the movement of the gripper in the first direction so that the gripper transfers the lens module at a depth at which the image is detected to be an image, which corresponds to a focal length of the lens to minimize a blurring phenomenon.

The gripper may further include a torque sensor for sensing a force applied to the pair of arms as the pair of arms move in the second direction.

When a torque detected by the torque sensor becomes a preset threshold torque while the pair of arms are moved in a direction in which the pair of arms move away from each other in the second direction according to driving of the first driving module, the control unit stops the driving of the first driving module to prevent the pair of arms from moving further in the direction in which the pair of arms move away from each other.

The first driving module may include: a first motor; and a first gear module for converting a movement force of the first motor into a linear movement force in opposite

directions to allow the pair of arms to be simultaneously moved in the opposite directions according to the movement force of the first motor, so that the pair of arms are moved in a direction in which the pair of arms move close to or away from each other according to driving of the first motor.

An outer surface of the lens module may include a cylindrical integrated outer surface, and the lens module may be fixed to the lens housing at a depth at which the lens module is inserted by the gripper by a single application of epoxy applied along the through-line while the lens module is supported by the gripper.

The control unit may allow the focal point detection module to capture a preset number of images in a preset depth unit, store a result of controlling the movement of the gripper in the first direction when an image formed on the lens is captured to be a clearest image as a result of analyzing the captured images, and control the movement of the gripper in the first direction so that the lens module is inserted into the insertion space at a depth at which the image formed on the lens is captured to be the clearest image.

### Advantageous Effects

According to the present invention, in order not to require any manual work of an operator, and in order to prevent any damage to a lens module and an insertion space and any improvement over a conventional product caused by an interference between the lens module and an inside of the insertion space, as the lens module is inserted along the insertion space while the lens module is firmly supported through a gripper for supporting the lens module on an inner surface of the lens module, the lens module may be located at a depth at which an image formed on a lens is the clearest by a focal point detection module, the lens module and the lens housing may be fixed to each other by using epoxy, and an operation of the gripper may be released, so that installation of the lens module may be completed.

Accordingly, the manual work and visual confirmation of the operator can be completely unnecessary, the lens module can be automatically disposed through precise insertion control, and the lens module can be installed in the lens housing through a single fixing process, so that a yield in manufacture of a device such as an optical sensor, which includes an installation process of the lens module that requires a precise work, can be greatly improved.

### DESCRIPTION OF DRAWINGS

FIGS. 1 to 3 are views for describing an installation process of a lens module by using a conventional technology.

FIG. 4 is a view showing a configuration of a precision insertion device for an insertion line of a lens module according to one embodiment of the present invention.

FIG. 5 is a view for describing a shape of an inner surface of a gripper according to one embodiment of the present invention.

FIG. 6 is a view for describing a difference between the conventional technology and a process of fixing the lens module to a lens housing according to the present invention.

FIG. 7 is a view for describing a function of a control unit according to another embodiment of the present invention.

FIG. 8 is a view for describing an example in which an insertion depth of a lens module is determined according to each embodiment of the present invention.

### BEST MODE

Hereinafter, various embodiments and/or aspects will be disclosed with reference to the drawings. In the following description, for the purpose of description, numerous specific details are set forth in order to facilitate an overall understanding of one or more aspects. However, it will also be appreciated by a person having ordinary skill in the art to which the present invention pertains that such aspect(s) may be practiced without the specific details. The following description and the accompanying drawings will be set forth in detail for specific illustrative aspects among the one or more aspects. However, the aspects are provided for illustrative purposes, some of various schemes based on principles of various aspects may be employed, and descriptions set forth herein are intended to include all the aspects and equivalents thereof.

The terms “embodiment”, “example”, “aspect”, “illustration”, and the like used herein may not be construed as indicating that any aspect or design set forth herein is preferable or advantageous over other aspects or designs.

In addition, it is to be understood that the terms “include” and/or “comprise” indicate the presence of corresponding features and/or elements, but do not preclude the presence or addition of one or more other features, elements, and/or groups thereof.

In addition, although the terms including ordinal numbers such as “first” and “second” may be used to describe various elements, the elements are not limited by the terms. The above terms are used merely for the purpose of distinguishing one element from another element. For example, a first element may be termed as a second element, and similarly, a second element may also be termed as a first element without departing from the scope of the present invention. The term “and/or” includes any combination of a plurality of described relevant items, or one of the described relevant items.

In addition, unless defined otherwise, all terms used in embodiments of the present invention, including technical and scientific terms, have the same meaning as those commonly understood by a person having ordinary skill in the art to which the present invention pertains. Any terms as those defined in generally used dictionaries are to be interpreted to have the meanings consistent with the contextual meanings in the relevant field of art, and are not to be interpreted to have idealistic or excessively formalistic meanings unless explicitly defined in the embodiments of the present invention.

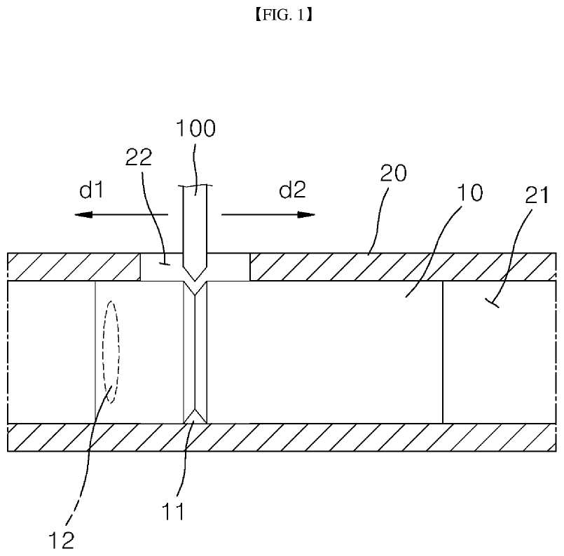

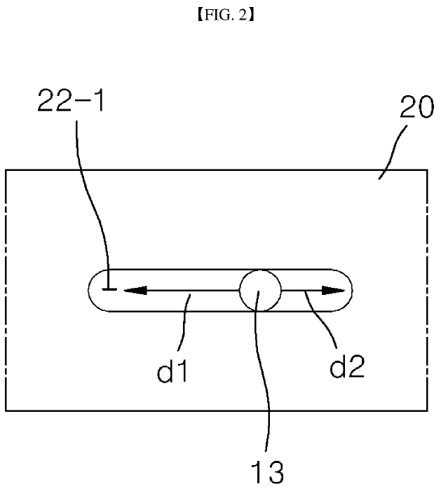

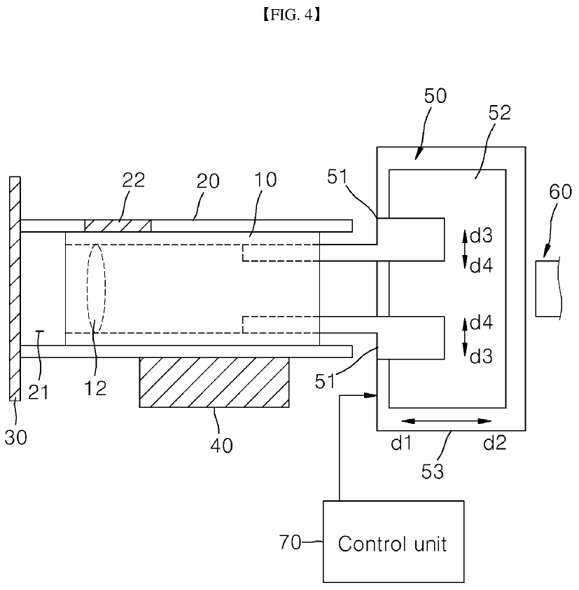

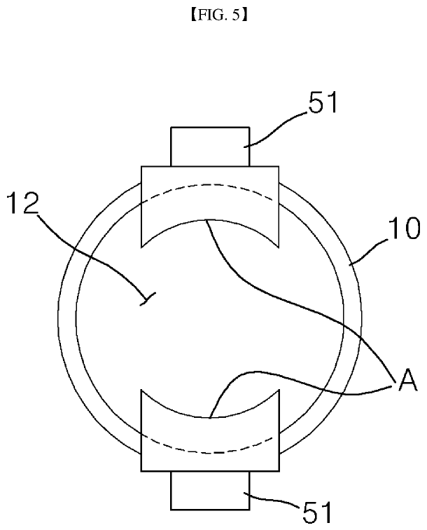

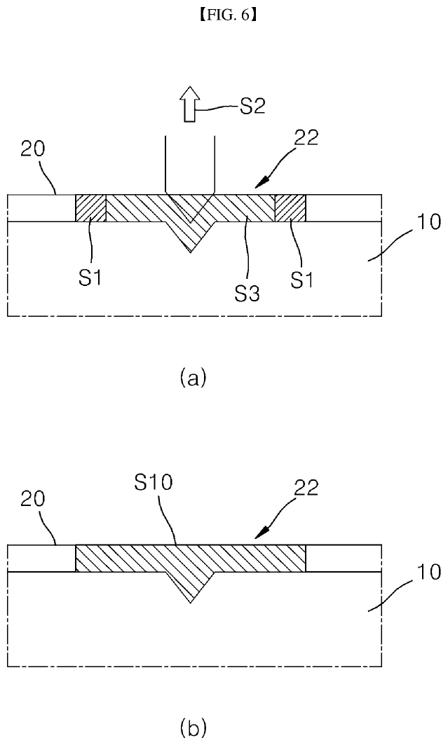

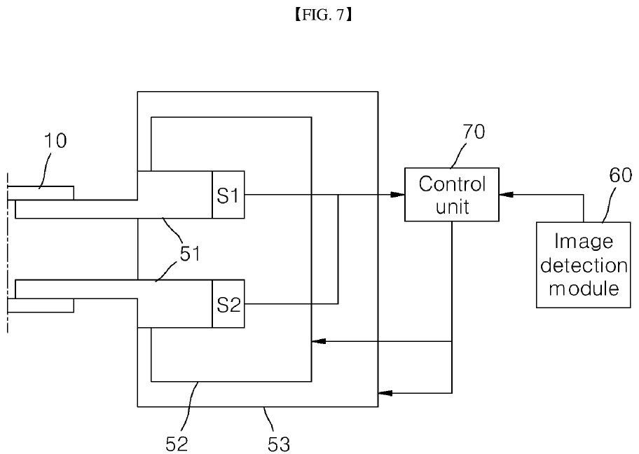

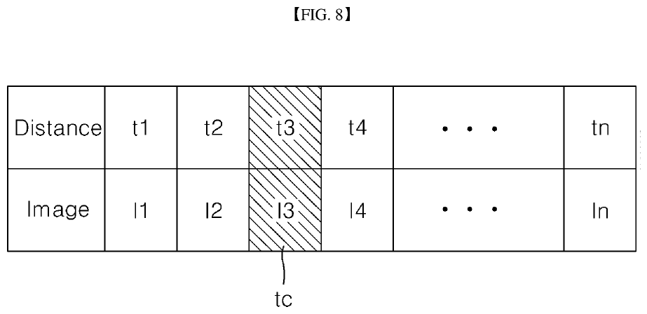

FIGS. 1 to 3 are views for describing an installation process of a lens module by using a conventional technology, FIG. 4 is a view showing a configuration of a precision insertion device for an insertion line of a lens module according to one embodiment of the present invention, FIG. 5 is a view for describing a shape of an inner surface of a gripper according to one embodiment of the present invention, FIG. 6 is a view for describing a difference between the conventional technology and a process of fixing the lens module to a lens housing according to the present invention, FIG. 7 is a view for describing a function of a control unit according to another embodiment of the present invention, and FIG. 8 is a view for describing an example in which an insertion depth of a lens module is determined according to each embodiment of the present invention.

Meanwhile, in the following description, although some components shown in the drawings have been omitted or excessively enlarged or reduced in order to describe a function of each of the components of the present invention, it is to be understood that the details shown in the drawings do not limit the technical features and scope of the present invention.

In addition, in the following description, a plurality of drawings may be simultaneously referenced in order to describe one technical feature or one element constituting the invention.

As described above, when described with reference to the drawings, a precision insertion device for an insertion line of a lens module according to one embodiment of the present invention (hereinafter referred to as a “device according to the present invention”) may include a lens housing fixing unit 40, a gripper 50, a focal point detection module 60, and a control unit 70.

The lens housing fixing unit 40 a stage for performing a function of fixing a lens housing 20, which has an insertion space into which a lens module having a cylindrical shape, having an end side coupled with a lens, and formed therein with an empty space is inserted, and a through-line formed through the lens housing 20 to allow one region of an outer surface of the lens housing 20 to be connected to the insertion space, at a predetermined position for the insertion of the lens module 10

The lens housing fixing unit 40 may refer to a configuration including a stage for performing a function of fixing a lens housing 20, which has an insertion space 21 into which a lens module 10 having a cylindrical shape, having an end side coupled with a lens 12, and formed therein with an empty space is inserted, and a through-line 22 formed through the lens housing 20 to allow one region of an outer surface of the lens housing 20 to be connected to the insertion space, at a predetermined position for the insertion of the lens module 10, and a fixing member.

The lens module 10 may refer to a component having an end side coupled with the lens 12 as described above, having a cylindrical shape, and having an empty space formed in a region corresponding to a traveling direction of a light directed toward the lens 12. In this case, the lens module 10 may be inserted along the insertion space 21 so as to be coupled to the lens housing 20. After the insertion into the insertion space 21, the lens module 10 and the lens housing 20 may be fixed to each other through coupling the outer surface of the lens module 10 to an inner surface of the lens housing 20 adjacent to the insertion space 21 by applying an adhesive member such as epoxy along the through-line 22 described above and curing the adhesive member.

The lens housing 20 may be, for example, an element having an end side coupled with a substrate 30 or the like and constituting a device such as an optical sensor including a LiDAR sensor described above, and may particularly refer to a configuration having the structure described above so that the lens module 10 may be inserted and fixed thereto.

The lens housing fixing unit 40 may perform a function of precisely fixing the lens housing 20 described above at a position for inserting the lens module 10. In other words, when the lens module 10 is fixed by the gripper 50 that will be described below, the position of the lens housing 20 may be fixed such that a three-dimensional position of the lens module 10 allows an end side of the lens module 10 to precisely match an opening of the insertion space 21 adjacent to the lens housing 20, and allows a longitudinal axis of the lens module 10 to match with a longitudinal axis of the insertion space 21.

According to the present invention, the lens housing 20 may vary depending on a type of an optical device described above, and the lens module 10 may also vary depending on a size and a type of the lens module 10 installed in one LiDAR sensor. Accordingly, the lens housing fixing unit 40 may be configured as a stage-type device capable of performing a three-dimensional movement as described above, and may include a plurality of precision control motors and gear modules, and a movable stage so that the lens housing 20 may be fixed to the lens housing fixing unit 40, and the lens housing 20 may be fixed at a precise position described above through a three-dimensional movement of the stage.

Meanwhile, the gripper 50 may be inserted into the lens module 10, that is, a cylindrical empty space described above, through an opening formed on an end side, which is opposite to the end side on which the lens 12 of the lens module 10 having the cylindrical shape is installed, so as to apply an external force toward an outer surface of a cylinder of the lens module 10 so that the lens module 10 may be supported while the external force is applied, and moved in a first direction d1 and d2, which is a longitudinal direction of the insertion space 21, to insert the lens module 10 into the insertion space 21.

In detail, the lens module 10, which is supported and fixed while being moved in the direction d1 and d2 within the insertion space 21, may be inserted into the insertion space 21, such that the movement in the direction d1 and d2 may be performed so as to be located at a depth (position) corresponding to a focal length described above.

In this case, the fundamental technical feature of the present invention is that, in the movement of the lens module 10, the gripper 50 may have a detailed configuration in which the gripper 50 applies an external force in a direction d3 in which the lens module 10 is spread while making contact with an inner surface of the lens module 10, that is, an inner surface of the cylindrical empty space, so as to support and fix the lens module 10, and allows the lens module 10 to move together as the gripper 50 moves in the direction d1 and d2.

In other words, in this case, after the lens module 10 is moved along the insertion space 21 without applying any external force or interference to a contact surface between the lens module 10 and the insertion space 21, for example, when the gripper 50 supports the lens module 10 in a direction d4 narrowing from the outer surface of the lens module 10, the outer surface of the lens module 10 may be

prevented from being making contact with an inner surface of the insertion space 21 as the outer surface of the lens module 10 is dented by an external force in a contact region between the lens module 10 and the gripper 50, so that a fixing force may be completely prevented from being reduced.

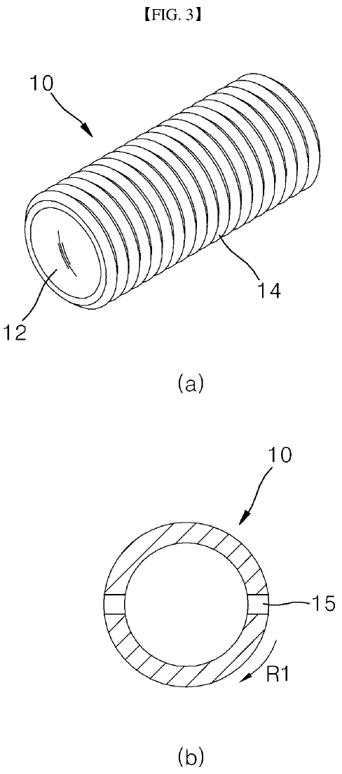

The focal point detection module 60 may have a detection angle in a direction toward the lens 12 along the empty space of the lens module 10 to detect a focal point of the lens 12 by using a function of capturing an image formed on the lens 12 or the like. In detail, the capturing angle may represent a capturing region, and a function of capturing an image corresponding to an image of the substrate 30 formed by the lens 12 in a positional relation shown in FIG. 3 may be performed.

Meanwhile, the focal point detection module 60 may be implemented as an image capturing device described above, and any sensor capable of detecting a focal point of a lens, such as a laser sensor, a distance sensor, and an optical sensor, may be used as the focal point detection module 60. In other words, laser and optical sensors may be used to emit a light or a laser to the lens, and detect an image formed on the lens through the emitted light or laser, so as to detect whether an insertion depth is an insertion depth corresponding to a distance at which the image is clearest, that is, the focal point of the lens 12. Hereinafter, although the focal point detection module 65 will be described as being implemented as a camera or the like, which is the easiest device to be implemented, it will be understood that the implementation may be performed according to all the embodiments described above.

According to the structural features that control the movement of the gripper 50 with respect to the lens module 10, the focal point detection module 60 may be installed on a side opposite to a side where the gripper 50 is directed toward the lens module 10 in a relation between the lens module 10 and the gripper 50 as shown in FIG. 3, and the gripper 50 may be configured such that a gap between arms 51, which will be described below, of the gripper 50 is open, for example, in order to allow the camera of the focal point detection module 60 to normally capture the image formed on the lens 12 described above during the capturing.

The control unit 70 may perform a function of controlling the movement of the gripper 50 in the first direction d1 and d2 according to a capturing result of the focal point detection module 60.

Among the configurations described above, the description of the specific configuration of the gripper 50 has been shown in FIGS. 4, 5, and 7.

Referring to the drawings described above together, the gripper 50 may include a pair of arms 51 moved in a radial direction d3 and d4 of the cylinder of the lens module 10 while being moved in the longitudinal direction d1 and d2 of the lens module 10, and having a portion inserted into the lens module 10 through the opening.

The arm 51 may be moved in the direction d1 from a default position, that is, from a position at which the pair of arms 51 almost make contact with each other while being spaced apart from the lens module 10 so as to be inserted into the cylindrical empty space of the lens module 10, and may be moved in the direction d3 so that the pair of arms 51 may be spread apart from each other to apply an external force while making contact with the inner surface of the lens module 10, so that the arm 51 may support the lens module 10 while applying a fixing force to the lens module 10.

Accordingly, when the arm 51 moves in the direction d1 and d2, the lens module 10 may also move in the direction d1 and d2 due to the fixing force with the lens module 10. Thereafter, when a process of arranging the lens module 10 at a position according to the insertion depth in the insertion space 21 in which a distance between the lens 12 and the substrate 30 exactly matches a focal length for each specification of the lens 12 as the movement in the direction d1 and d2 is controlled by the control unit 70 and fixing the lens module 10 to the lens housing 20 is completed as described above, the pair of arms 51 may be moved in the direction d4 so that a fixing/supporting force for the lens module 10 may be released, and may be controlled to move completely in the direction d2, thereby completing a process of fixing and installing the lens module 10 to the lens housing 20.

The gripper 50 may include a first driving module 52 for providing a movement force for moving the pair of arms in a second direction, which is the direction d3 and d4 for the arms 51, that is, the radial direction of the lens module 10. In addition, correspondingly, the gripper 50 may include a second driving module 53 for controlling the movement of the pair of arms 51 in the direction d1 and d2, that is, the first direction.

As described above, an outer surface of the lens module 10 may include a cylindrical integrated outer surface, and the lens module 10 may be fixed to the lens housing 20 at a depth at which the lens module 10 is inserted by the gripper 50 by a single application of epoxy applied along the through-line 22 while the lens module 10 is supported by the gripper 50.

In other words, referring to FIG. 6, first, according to the conventional technology in which the pin 100 is inserted into the groove part to adjust the insertion depth of the lens module 10 by the external force of the operator as shown in FIG. 6(a), first, a first process S1 of applying epoxy to a through-line 22, that is, both end side portions of a slit, which are regions where the pin 100 is not disposed, may be performed. This is intended to prevent the pin 100 from being fixed together when the epoxy is applied to the pin 100. Thereafter, a second process S2 of removing the pin 100 may be performed, and a third process S3 of applying the epoxy to a space in which the pin 100 was disposed may be performed.

In this case, while the epoxy is not completely cured, the pin 100 may be removed in the process S2, and the process S3 of applying additional epoxy may be performed. At this point, an external force may be applied when the pin 100 is removed or the additional epoxy is applied, so that positions of the lens housing 20 and the lens module 10, which are not completely fixed, may be slightly moved from original positions. In this case, the insertion depth of the lens module 10 may not be adjusted after the epoxy is fixed, so that precise production of the optical sensor may be difficult.

However, according to the present invention as shown in FIG. 6(b), position control by the pin or the like may be completely unnecessary, and while the lens module 10 is supported by contact between the arm 51 and the inner surface of the lens module 10 to have a position that is completely fixed as described above, the lens module 10 may be fixed to the lens housing 20 through a single epoxy application process S10, so that the positions of the lens housing 20 and the lens module 10 may be completely prevented from being slightly moved from the original positions.

Meanwhile, since the first driving module 52 is only required to move in the direction d3 and d4 to move in a direction in which the arms 51 move away from or close to each other, the first driving module 52 may include: a first motor; and a first gear module for converting a movement force of the first motor into a linear movement force in opposite directions to allow the pair of arms 51 to be simultaneously moved in the opposite directions according to the movement force of the first motor, so that the pair of arms 51 may be moved in a direction d3 and d4 in which the pair of arms 51 move close to or away from each other according to driving of the first motor.

Regarding the movement in the direction d3 and d4, when the lens module 10 is moved excessively in the direction d3 without being inserted, a cylindrical outer shape of the lens module 10 may be damaged by the arm 51. In addition, when the movement in the direction d3 and d4 is not precisely controlled even in a case where the lens module 10 is inserted, the lens module 10 and the lens housing 20 may be damaged together as described above, or the lens module 10 may not be completely supported so that the movement of the arm 50 in the direction d1 and d2 may not be completely converted into the movement of the lens module 10.

In order to prevent such a phenomenon, according to another embodiment of the present invention, as shown in FIG. 7, the gripper 50, specifically the first driving module, may further include torque sensors S1 and S2 for sensing torques applied to the pair of arms 51 as the pair of arms 51 move in the second direction d3 and d4.

According to the example described above, when the pair of arms 51 make contact with the inner surface of the lens module 10 to apply an external force to the inner surface, the sensors S1 and S2 may measure a reaction force, that is, a withstanding force caused by the external force. In other words, the force applied to the pair of arms 51, for example, a torque of the first motor and a force corresponding to a resistance force for the torque may be measured.

In this case, when the torque detected by each of the torque sensors S1 and S2 becomes a preset threshold torque while the pair of arms 51 are moved in a direction d3 in which the pair of arms 51 move away from each other in the second direction d3 and d4 according to driving of the first driving module, the control unit 70 may control the driving of the first driving module to stop the driving of the first driving module to prevent the pair of arms 51 from moving further in the direction d3 in which the pair of arms 51 move away from each other.

Accordingly, when the movement in the direction d3 and d4 is not precisely controlled even in a case where the lens module 10 is inserted, it is possible to solve the problem that the lens module 10 and the lens housing 20 may be damaged together as described above, or the lens module 10 may not be completely supported so that the movement of the arm 50 in the direction d1 and d2 may not be completely converted into the movement of the lens module 10.

Meanwhile, as described above, according to the structural features that control the movement of the gripper 50 with respect to the lens module 10, the focal point detection module 60 may be installed on a side opposite to a side where the gripper 50 is directed toward the lens module 10 in a relation between the lens module 10 and the gripper 50 as shown in FIG. 3, and the gripper 50 may be configured such that a gap between arms 51, which will be described below, of the gripper 50 is open, for example, in order to allow the camera of the focal point detection module 60 to normally capture the image formed on the lens 12 described above during the capturing.

To this end, according to one embodiment of the present invention, as shown in FIG. 5, a shape of an inner surface A of the arm 51 may be formed such that a line that connects inner surfaces A of the pair of arms 51 forms a circle. Accordingly, the image detection device 60 may completely capture the image formed on the lens 12.

As described above, the image detection device 60 may include: a camera for capturing an image toward a gap between the pair of arms 51 in the direction toward the lens 12 along the cylindrical empty space of the lens module 10 to captures an image of a substrate 30 formed by the lens 12; and a communication module for transmitting the image captured by the camera to the control unit 70 in a real time.

In this case, as shown in FIG. 7 and the like, the control unit 70 may use an image formed on the lens 12, that is, an image produced on the lens 12, among images received through the communication module to control the movement of the gripper 50 in the first direction d1 and d2 so that the gripper 50 may transfer the lens module 10 at a depth at which the image is detected to be an image corresponding to a focal length of the lens 12 to minimize a blurring phenomenon, that is, the clearest image. In other words, according to the example described above, driving of the second driving module 53 may be controlled.

In this case, the control unit 70 may control the movement of the gripper 50 in the first direction d1 and d2 by using a data table shown in FIG. 8.

In other words, the control unit 70 may allow the focal point detection module to capture a preset number (e.g., 20 in a unit of 10 um) of images in a preset depth unit at each of distances t1 to tn, and store a result of controlling the movement of the gripper in the first direction at a distance t3 at which an image formed on the lens is captured to be a clearest image I3 as a result of analyzing the captured images I1 to In or a movement control distance tc of the clearest image I3.

In other words, the control unit may allow the focal point detection module to capture a preset number of images in a preset depth unit, store a result of controlling the movement of the gripper in the first direction when an image formed on the lens is captured to be a clearest image as a result of analyzing the captured images, and control the movement of the gripper in the first direction so that the lens module is inserted into the insertion space at a depth at which the image formed on the lens is captured to be the clearest image.

In detail, the above control may be performed as follows. In other words, each of unit distances t1 to tn may be controlled in a wide unit of 100 um upon control of a first cycle. In this case, the distance tc at which the clearest image is formed may be stored, insertion may be controlled to be performed at the distance tc after the control is completed, and the distance control may be repeatedly performed to perform a reciprocal movement at the distance tc, such that the unit distance may be reduced to 10 um upon control of a second cycle. In this case, when a distance at which a clearest image is formed is detected even in the second cycle, control of a third cycle for storing the distance, performing a movement at the distance, recognizing the distance as a default position, and performing a movement to each of both sides with respect the distance by a distance of 10 um may be performed. At this point, the unit distance may be reduced to 1 um, so that the distance at which the clearest image is formed in the third cycle may be finally determined as the focal length, that is, a threshold distance described above.

Accordingly, a manual work of the operator may be completely unnecessary, and the insertion depth of the lens module 10 within the insertion space 21 may be controlled very precisely to a precise target position corresponding to the focal length, so that a manufacturing yield of a device such as an optical sensor may be greatly improved.

Although the embodiments have been described above with reference to specific embodiments and drawings, it will be understood by those skilled in the art that various modifications and variations can be made from the above description. Since a term such as “include”, “comprise”, or “have” described above means that an element that is not explicitly described to the contrary may be included, it should be interpreted that other elements may be further included but not excluded. In addition, the scope of the present invention should be interpreted by the appended claims, and should be construed as encompassing all technical ideas within the scope of equivalents thereof.

1. A precision insertion device for an insertion line of a lens module, the precision insertion device comprising:
a lens housing fixing unit for fixing a lens housing, which has an insertion space into which a lens module having a cylindrical shape, having an end side coupled with a lens, and formed therein with an empty space is inserted, and a through-line formed through the lens housing to allow one region of an outer surface of the lens housing to be connected to the insertion space;
a gripper inserted into the lens module through an opening formed on an end side, which is opposite to the end side on which the lens of the lens module having the cylindrical shape is installed, so as to apply an external force toward an outer surface of a cylinder of the lens module to support the lens module, and moved in a first direction, which is a longitudinal direction of the insertion space, to insert the lens module into the insertion space;
a focal point detection module having a capturing angle in a direction toward the lens along the empty space of the lens module so as to detect a focal point of the lens; and
a control unit for controlling the movement of the gripper in the first direction according to a capturing result of the focal point detection module.

2. The precision insertion device of claim 1, wherein the gripper includes:
a pair of arms moved in a radial direction of the cylinder of the lens module while being moved in the longitudinal direction of the lens module, and having a portion inserted into the lens module through the opening;
a first driving module for providing a movement force for moving the pair of arms in a second direction, which is the radial direction of the lens module; and
a second driving module for providing a movement force for moving the pair of arms in the first direction.

3. The precision insertion device of claim 2, wherein a shape of an inner surface of the arm is formed such that a line that connects inner surfaces of the pair of arms forms a circle.

4. The precision insertion device of claim 2, wherein the focal point detection module includes:
a camera for capturing an image toward a gap between the pair of arms in the direction toward the lens along the empty space of the lens module; and
a communication module for transmitting the image captured by the camera to the control unit in a real time.

5. The precision insertion device of claim 4, wherein the control unit uses an image formed on the lens among images received through the communication module to control the movement of the gripper in the first direction so that the gripper transfers the lens module at a depth at which the image is detected to be an image, which corresponds to a focal length of the lens to minimize a blurring phenomenon.

6. The precision insertion device of claim 2, wherein the gripper further includes a torque sensor for sensing a force applied to the pair of arms as the pair of arms move in the second direction.

7. The precision insertion device of claim 6, wherein, when a torque detected by the torque sensor becomes a preset threshold torque while the pair of arms are moved in a direction in which the pair of arms move away from each other in the second direction according to driving of the first driving module, the control unit stops the driving of the first driving module to prevent the pair of arms from moving further in the direction in which the pair of arms move away from each other.

8. The precision insertion device of claim 2, wherein the first driving module includes:
a first motor; and
a first gear module for converting a movement force of the first motor into a linear movement force in opposite directions to allow the pair of arms to be simultaneously moved in the opposite directions according to the movement force of the first motor, so that the pair of arms are moved in a direction in which the pair of arms move close to or away from each other according to driving of the first motor.

9. The precision insertion device of claim 1, wherein an outer surface of the lens module includes a cylindrical integrated outer surface, and
the lens module is fixed to the lens housing at a depth at which the lens module is inserted by the gripper by a single application of epoxy applied along the through-line while the lens module is supported by the gripper.

10. The precision insertion device of claim 1, wherein the control unit allows the focal point detection module to capture a preset number of images in a preset depth unit, stores a result of controlling the movement of the gripper in the first direction when an image formed on the lens is captured to be a clearest image as a result of analyzing the captured images, and controls the movement of the gripper in the first direction so that the lens module is inserted into the insertion space at a depth at which the image formed on the lens is captured to be the clearest image.
